(19) United States
(12) Patent Application Publication
(10) Pub. No.: US 2016/0060877 A1
(43) Pub. Date: Mar. 3, 2016

(54) Adhesive wall panel

(71) Applicant: David Witschi, Gage, OK (US)

(72) Inventor: David Witschi, Gage, OK (US)

(21) Appl. No.: 14/840,189

(22) Filed: Aug. 31, 2015

Related U.S. Application Data
(60) Provisional application No. 62/043,808, filed on Aug. 29, 2014.

(51) Int. Cl. E04F 13/08; C09J 7/00; B32B 7/06

(52) U.S. Cl. CPC E04F 13/0885; B32B 7/06; C09J 7/00; B32B 2607/00; B32B 2405/00

(57) ABSTRACT

An adhesive wall panel provides a thin layer of drywall or paneling with peel-and-stick backing, for mounting on an existing wall or on particle board or plywood. The peel-and-stick backing is comprised of a thin layer of strong, permanent adhesive, preferably covered with a thin cover sheet of plastic or similar durable material which may be peeled away immediately before installation.

### CROSS-REFERENCE TO RELATED APPLICATIONS

This Application claims the benefit of U.S. Provisional Application No. 62/043,808, filed Aug. 29, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to construction materials and in particular to an adhesive wall panel. On some construction and remodeling projects, drywall or wooden paneling is being installed where a wall already exists. On other projects, drywall or paneling is desired as an outer surface, but a more structurally durable base layer is desired. These construction and remodeling methods produce a top quality wall surface, but are quite labor intensive and costly, and an alternative would be well received. An adhesive wall panel, providing a thin layer of drywall or paneling with peel-and-stick backing, for rapid mounting on an existing wall or on particle board or plywood, without the use of nails or drywall tape, would resolve this problem.

### SUMMARY OF THE INVENTION

Accordingly, the invention is directed to an adhesive wall panel. The panel provides a thin layer of drywall or paneling with peel-and-stick backing, for mounting on an existing wall or on particle board or plywood. The peel-and-stick backing is comprised of a thin layer of strong, permanent adhesive, preferably covered with a thin cover sheet of plastic or similar durable material which may be peeled away immediately before installation.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a rear close-up view of the first exemplary embodiment with the cover sheet partially peeled away, displaying the panel 10, the adhesive 11, and the cover sheet 12.

FIG. 2 is a side perspective close-up view of the first exemplary embodiment with the cover sheet partially peeled away, displaying the panel 10, the adhesive 11, and the cover sheet 12.

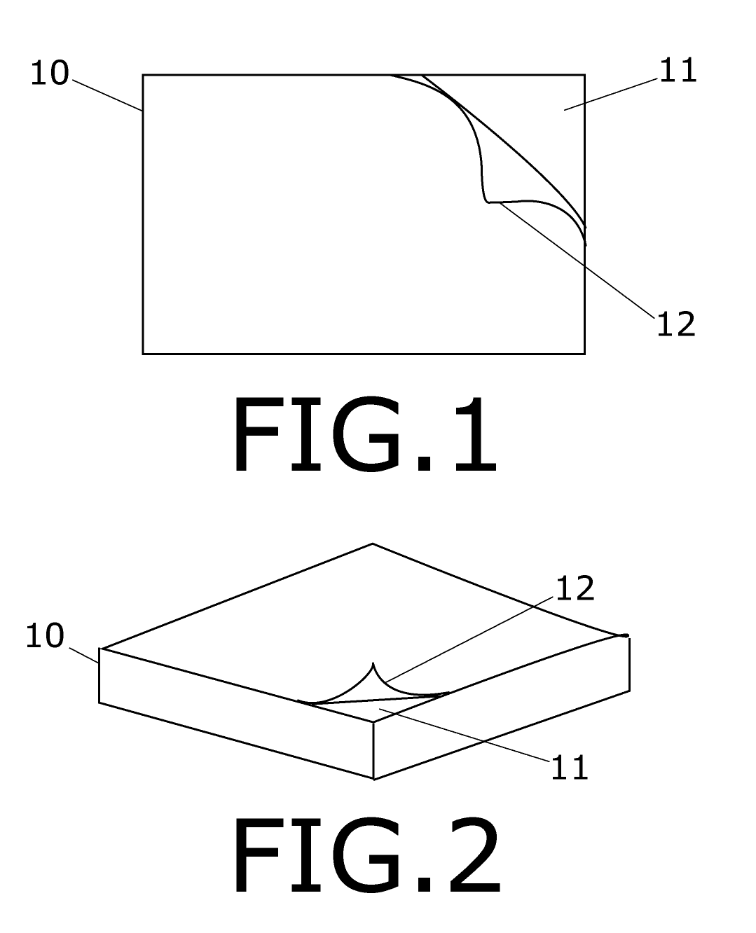

### DETAILED DESCRIPTION OF THE INVENTION

Referring now to the invention in more detail, the invention is directed to an adhesive wall panel 10.

The first exemplary embodiment provides a wall panel 10, comprised of a thin layer of drywall. The panel 10 provides a peel-and-stick backing, for mounting on an existing wall or on particle board or plywood. The peel-and-stick backing is comprised of a thin layer of strong, permanent adhesive 11, preferably covered with a thin cover sheet 12 of plastic or similar durable material which may be peeled away immediately before installation. The edges of the wall panel 10 create a small V-groove when two panels are placed next to each other. The V-groove being one-eighth to one-fourth of an inch wide on all four edges. A pliable and sandable caulking is applied with caulking gun and does not shrink. The caulking may be smoothed out with a small putty knife and sanded if necessary. The invention enables the user to rapidly install wall panels 12, without requiring nails or drywall tape.

The second exemplary embodiment is structurally and functionally identical to the first exemplary embodiment, except that it provides a wall panel 10, comprised of a thin layer of wooden paneling.

To use the first or the second exemplary embodiment, the user peels away the cover sheet 12 from the rear surface of the wall panel 10, exposing the adhesive 11. The user then presses the wall panel 10 against the wall or base layer in the desired position, enabling the adhesive 11 to adhere to the wall or base layer.

The wall panel 10 is preferably manufactured from a rigid, durable material such as gypsum or wood. The cover sheet 12 is preferably manufactured from a flexible, durable material, such as plastic, paper, cellophane, or acetate. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An adhesive wall panel, comprising:
(a) a wall panel;
(b) an adhesive layer;
(c) said adhesive layer being located on a back side of said wall panel;
(d) said adhesive layer being a strong and permanent adhesive;
(e) a thin cover sheet; and
(f) said thin cover sheet being removably placed over said adhesive layer.
